(19) United States
(12) Patent Application Publication
(10) Pub. No.: US 2026/0235875 A1
(43) Pub. Date: Aug. 13, 2026

(54) WAVELENGTH AND DIFFRACTIVE MULTIPLEXED EXPANSION OF FIELD OF VIEW FOR DISPLAY DEVICES

(71) Applicant: ARIZONA BOARD OF REGENTS ON BEHALF OF THE UNIVERSITY OF ARIZONA, Tucson, AZ (US)

(72) Inventors: Yuzuru TAKASHIMA, Tucson, AZ (US); Pengyu LIU, Tucson, AZ (US); Ted LEE, Tucson, AZ (US)

(21) Appl. No.: 18/730,412

(22) PCT Filed: Jan. 23, 2023
(86) PCT No.: PCT/US2023/011311

§ 371 Date: Jul. 19, 2024

Related U.S. Application Data
(60) Provisional application No. 63/301,577, filed on Jan. 21, 2022.

(51) Int. Cl. G02B 27/01; G02B 27/28; H04J 14/02

(52) U.S. Cl. CPC G02B 27/0172; G02B 27/283; H04J 14/02; G02B 2027/0123; G02B 2027/0174; G02B 2027/0178

(57) ABSTRACT

In a method for transferring an image over an angularly bandlimited optical data channel, a plurality of sub-images is defined that together make up an original image to be transferred over the data channel. Each of the sub-images have a field-of-view (FOV) less than a FOV of the original image and is able to be transferred through the data channel without losing information due to the limited FOV of the data channel. The sub-images are generated from the original image such that the sub-images are able to be transferred into the data channel using (i) time multiplexing and (ii) wavelength and/or polarization multiplexing such that the sub-images are spatially superimposed while traversing the data channel. The spatially superimposed sub-images are transferred into the data channel and subsequently outcoupled. The outcoupled spatially superimposed sub-images are spatially expanded to reconstruct the original image using a wavelength and/or polarization demultiplexing device.

### CROSS-REFERENCE TO RELATED APPLICATION

This application claims the benefit of U.S. Provisional Application Ser. No. 63/301,577, filed Jan. 21, 2022, the contents of which are incorporated herein by reference.

### BACKGROUND

Recently, optical systems for Augmented Reality (AR), Mixed Reality (MR) and Virtual Reality (VR) have gained attention since they interface the human world to the virtual world. Such optical systems ideally require a high optical resolution and a large field of view (FOV). In addition, providing a depth cue to the human eye is important to avoid vergence accommodation conflicts, which is one of the causes of the dizziness users often encounter. To accommodate a wide FOV, high resolution and 3D images, the amount of image information that needs to be conveyed can be quite large. Consequently, the increased amount of image information requires high-capacity optical channels. Often, AR/VR/MR systems are required to have a small form factor, which can conflict with the provision of a high-capacity optical channel.

### SUMMARY OF THE INVENTION

In accordance with one aspect of the subject matter described herein, a method for transferring an image over an angularly bandlimited optical data channel is provided. In accordance with the method, a plurality of sub-images is defined that together make up an original image to be transferred over the angularly bandlimited optical data channel. Each of the sub-images has a field-of-view (FOV) less than a FOV of the original image and is able to be transferred through the data channel without losing information due to the limited FOV of the data channel. The sub-images are generated from the original image such that the sub-images are able to be transferred into the data channel using (i) time multiplexing and (ii) wavelength and/or polarization multiplexing such that the sub-images are spatially superimposed while traversing the optical data channel. The spatially superimposed sub-images are transferred into the optical data channel. The spatially superimposed sub-images are outcoupled from the optical data channel. The outcoupled spatially superimposed sub-images are spatially expanded to reconstruct the original image using a wavelength and/or polarization demultiplexing device.

In one embodiment, the wavelength and/or polarization demultiplexing device is configured to angularly direct each of the sub-images to a designated FOV of the original image to thereby reconstruct the original image.

In another embodiment, the wavelength and/or polarization demultiplexing device includes at least a plurality of volume holographic gratings (VHGs) arranged one over another.

In another embodiment, the wavelength and/or polarization demultiplexing device further includes a polarization sensitive device.

In another embodiment, the polarization sensitive device is a wire grid polarizer.

In another embodiment, 6 the optical data channel is an image guide device in which the spatially superimposed sub-images undergo total internal reflection.

In another embodiment, the image guide device is incorporated in an augmented reality near-eye device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1a-1f show one example of an overall spatial or angular compression and decompression process at a high conceptual level, which may be used to transfer an optical image over an angularly bandlimited optical data channel.

FIG. 2a shows three segments of an original image before and after the steps shown in FIGS. 1a-1c have been performed;

FIG. 2b shows a simplified example of an optical system that can be used to perform the method shown in FIG. 1;

FIG. 2c shows the volume hologram grating (VHG) stack of FIG. 2b in more detail;

FIG. 2d shows the orientation of the grating vectors K of the VHGs L1, L2 and L3 shown in FIG. 2c; and

FIG. 2e shows an image of the holograms in VHGs L1, L2, and L3 produced by exposure using a commercial hologram film.

FIG. 3 shows three examples of how wavelengths and polarization states may be assigned to segments of an original image having a relatively large field of view (FOV).

FIG. 4 shows an example of a spatial or angular expander or demultiplexer that employs a 2-layer VHG stack plus a polarization sensitive device such as a Wire Grid Polarizer (WGP).

FIG. 5 shows another example of a spatial or angular expander or demultiplexer that employs a 2-layer VHG stack plus a polarization sensitive device such as a Wire Grid Polarizer (WGP).

FIG. 6a shows a conventional augmented reality (AR) near eye display (NED) and

FIG. 6b shows an AR-NED that employs the systems and techniques described herein.

FIG. 7 is flowchart showing one example of a method for transferring an image over an angularly bandlimited optical data channel.

### DETAILED DESCRIPTION

In one aspect, the subject matter described herein provides a method to compress (or multiplex) the angular extent or field of view (FOV) of an image by a factor of N, where N is a number of wavelengths and/or polarization states assigned to different portions of the image. After the compressed or multiplexed image is transferred via an optical data channel such as free-space or an image guide device (e.g., a waveguide plate such as used in a mixed reality device), the compressed image is de-compressed (or de-multiplexed) by using a volume holographic grating stack that is sensitive to the angle of incidence and wavelength and/or polarization state. An important advantage of this technique is that less angular bandwidth is required for the image transfer than in the conventional un-compressed case, and, consequently, the information density per optical channel is enhanced. In this way image transfer via an angularly bandwidth limited and space limited optical channel such as an image guide device of the type often employed in small form factor AR, MR and VR systems can be achieved.

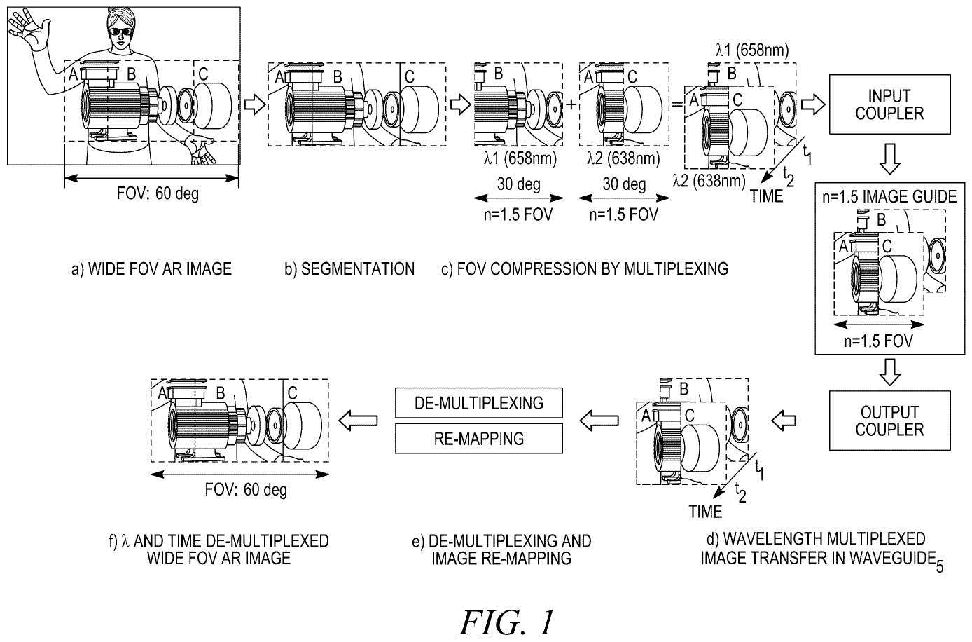

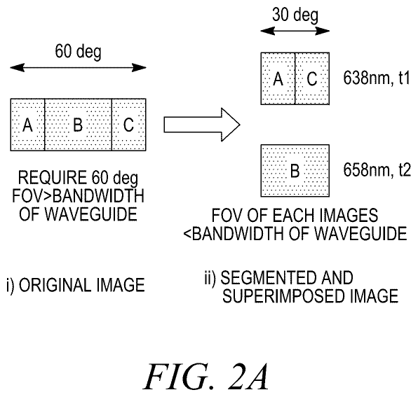

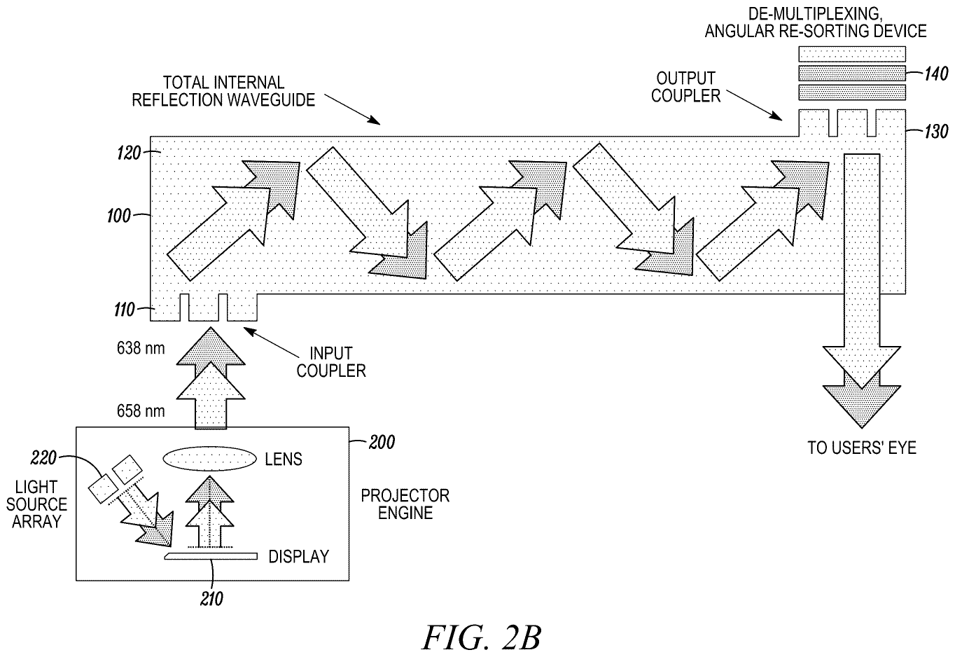

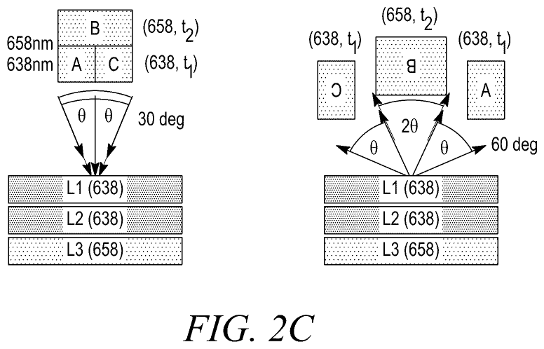

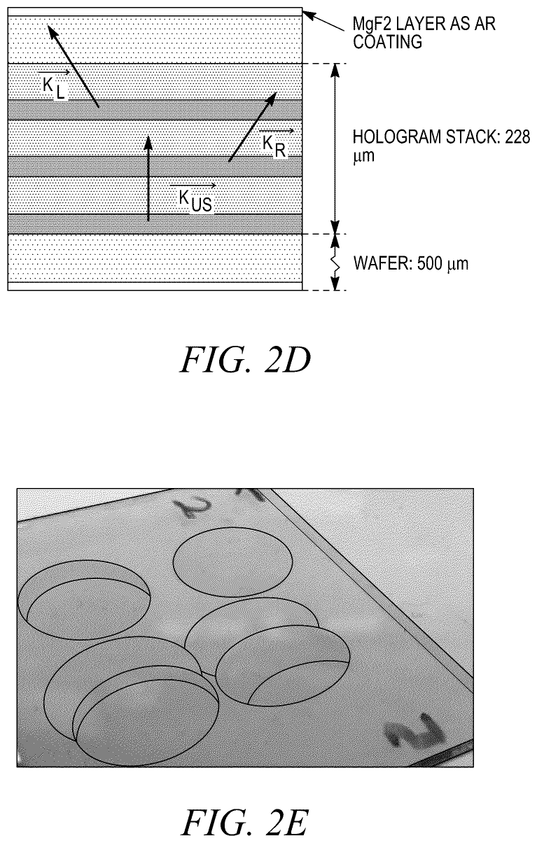

FIG. 1 depicts the overall spatial or angular compression and decompression process at a high conceptual level, which may be used to transfer an optical image over an angularly bandlimited optical data channel. In this example a scenario is considered in which an image with a 60 degree FOV is displayed using a 30 degree FOV image guide (e.g. a waveguide plate or the like that operates in accordance with total internal reflection and has n=1.5). FIG. 1a shows the original wide FOV image. First, as shown in FIG. 1b, the 60 degree total FOV image is divided into sub-images (or segmented images) each having a sub-FOV. Each of the sub FOVs is matched to the FOV of the image guide device. As shown in FIG. 1c, orthogonal optical parameters such as wavelengths and/or polarization states are assigned to each sub or segmented image. Next, in FIG. 1d the segmented images with the sub FOVs are transferred to the image guide device via an input coupler using time multiplexing. Since the sub FOV of the segmented images is smaller than the FOV of the image guide device, information is not lost during the transfer process. After the image is out-coupled from the image transfer device, demultiplexing or spatial decompression and re-mapping of the image is employed in FIG. 1e so that the original image can be perceived by the user. FIG. 1f shows the resulting image after it has been reconstructed by being angularly decompressed. The resulting image is effectively time demultiplexed by keeping the time multiplexing (i.e., the difference in time assigned to the different segmented images) sufficiently short so that the human eye perceives them as being simultaneous. A simplified example of an optical system (e.g., an AR, MR or VR system) that can be used to perform the method shown in FIG. 1 is depicted with reference to FIG. 2 (specifically, in FIG. 2b). Similar to what is shown in FIG. 1, FIG. 2a shows the original image being segmented into three sub or segmented images A, B and C. In this example segmented images A and C (the peripheral segmented images) are assigned an optical wavelength of 638 nm and segmented image B (the central segmented image) is assigned an optical wavelength of 658 nm. The wavelength separation of 20 nm is chosen in this particular example to maximize the color gamut while minimizing crosstalk between the images. Of course, more generally, other wavelengths with different wavelength separations may be employed.

FIG. 2a thus depicts the three segmented images before and after the steps shown in FIGS. 1a-1c have been performed. These steps may be performed, for example, by a projector arrangement or engine, an example of which is discussed below in connection with FIG. 2b.

FIG. 2b shows the optical system 100 that receives the segmented images from the projector engine 200. The projector engine 200 includes a display device 210 such as a digital micromirror display (DMD) or a micro-electromechanical (MEMs) based display device, for example. The projector engine 200 also includes light sources 220 such as LEDs or lasers that direct the light to the display device (which may operate in a transmissive or reflective mode). Synchronization electronics (not shown) such as a microcontroller are employed by the projector engine 200 so that the appropriate wavelength is directed to the display device 210 at the appropriate time.

As further shown in FIG. 2b, the segmented images from the projector engine 200 are received at an input coupler 110 of the optical system 100. The input coupler 110 directs the light into an optical data channel (i.e., image guide device 120), which in this example is a waveguide plate operating by total internal reflection (TIR). After the segmented images propagate through the image guide device 120 they are output by an output coupler 130 and directed to a volume hologram grating (VHG) stack 140 that decompresses or angularly expands the segmented images to reconstruct the original image. That is, the input coupler 110, the image guide device 120 and the output coupler 130 shown in FIG. 2b perform the steps illustrated in FIG. 1d. Likewise, the VHG stack 140 shown in FIG. 2b performs the steps shown in FIGS. 1e and 1f. Operation of the VHG stack 140 is shown in the FIG. 2c.

The VHG stack shown in FIG. 2c includes three VHGs denoted VHG L1, VHG L2 and VHG L3. In operation, the sub image “B” at 658 nm is reflected by VHG L3 and it forms central segmented image with an FOV of 30 degrees, whereas sub images “A” and “C” at 638nm are offset in FOV by the VHGs L2 and L3, respectively, and form the peripheral segmented images with FOVs of 15 degrees each. The VHG stack with VHGs L1, L2 and L3 stack is designed such that i) 685nm light only interacts with VHG L3, ii) 638 nm light only interacts with VHGs L1 and L2, and iii) the sub image “A” only interacts with VHG L2 and sub image “C” interacts with VHG L1. The orientation of the grating vectors K of the VHGs L1, L2 and L3 is shown in FIG. 2d. In some implementations the holograms in VHGs L1, L2, and L3 may be produced by exposure using a commercial hologram film such as Lithiholo (see FIG. 2e). In the particular example illustrated in FIG. 2 e, the film thickness is 16 um, and the index modulation at 650 nm is 0.02~0.03. After fabrication, the individual exposed holograms were pealed off from their substrates and stacked together.

The VHG stack of FIG. 2c thus performs wavelength demultiplexing to accomplish FOV spatial or angular expansion.

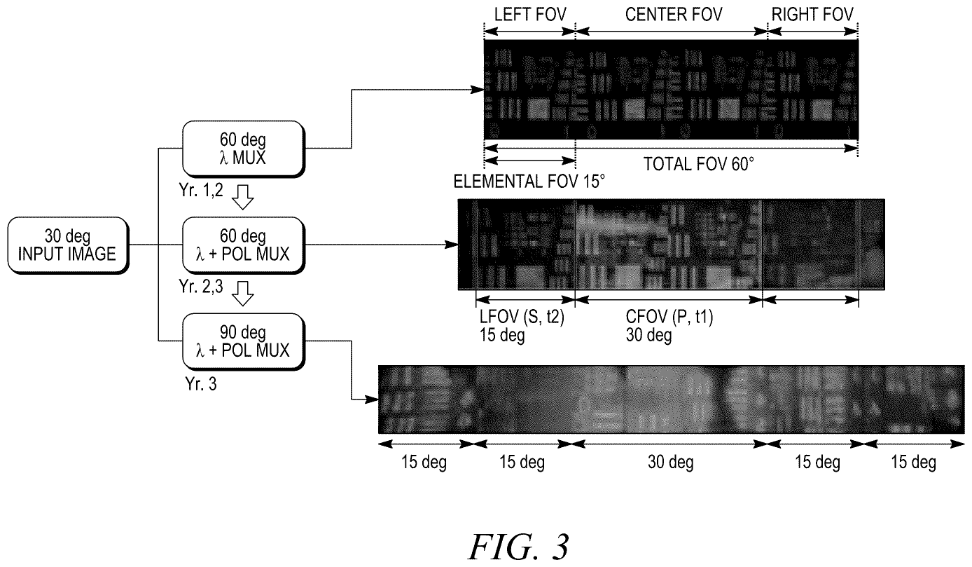

FIG. 3 shows three examples of how wavelengths and polarization states may be assigned to segments of an original image having a relatively large FOV. In the uppermost example an original 60 degree FOV image is segmented by wavelength into three sub-images, where the center sub-image is assigned one wavelength and the left and right sub-images are assigned another wavelength. Thus, this uppermost example employs only wavelength multiplexing. In the middle example shown in FIG. 3 the original image with a 60 degree FOV is segmented using two wavelength and different orthogonal polarization states, where the center sub-image is assigned one polarization state and with 658 nm of wavelength, the left sub-image is assigned an orthogonal polarization state with 638 nm and the right sub-image is assigned wavelength of 638 nm too different from that used in the center sub-images. Finally, in the bottom example shown in FIG. 3 an original image with a 90 FOV is segmented using two wavelengths and different orthogonal polarization states. Thus, in the middle and bottom examples shown in FIG. 3 both wavelength and polarization multiplexing are employed.

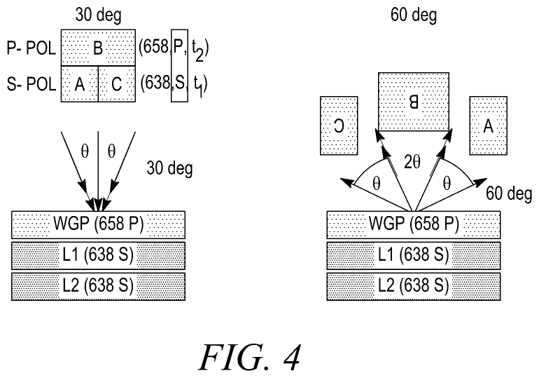

In implementations employing polarization multiplexing as well as wavelength multiplexing the 3-layer VHG stack such as shown in FIG. 2 may be replaced with a 2-layer VHG stack plus a polarization sensitive device such as a Wire Grid Polarizer (WGP), which is depicted in FIG. 4. In FIG. 4, the original 60 degree image is divided into sub images “A”+“C” assigned a wavelength of 638 nm and S polarization, while the sub image “B” is assigned a wavelength of 658 nm with P polarization having a 30 degree angular bandwidth. As shown, wavelength/polarization de-multiplexing and re-mapping is accomplished using a 2-layer VHG stack with VHGs L1 and L2 and a Wire Grid Polarizer (WGP). In one implementation the VHG-WGP stack may be fabricated with a single exposure of t=16 um photopolymer and the subsequent stacking of the holograms on top of the WGP. The wavelength/polarization hybrid multiplexing shows the same FOV as wavelength multiplexing while advantageously decreasing crosstalk among the wavelength multiplexed images. The stacked arrangement of FIG. 4 thus performs both wavelength and polarization demultiplexing to accomplish FOV spatial or angular expansion.

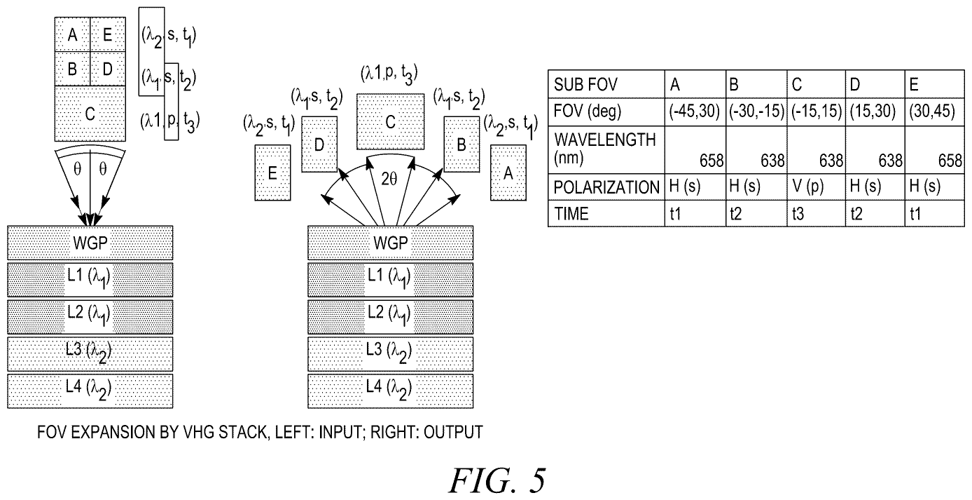

FIG. 5 shows another example of wavelength and polarization hybrid multiplexing to demonstrate the display of an original image with a 90 degree FOV, such as shown in the bottom example of FIG. 3. In addition to the 3 layer stack depicted in FIG. 4, the stack shown in FIG. 5 employs two additional VHGs denoted VHG L3 and VHG L4, which in this example operate at a wavelength of 658 nm to accommodate the extreme peripheral images with a FOV at −45 degrees to about 30 degrees and +30 degrees to about +45 degrees. Similar to the stacked arrangement shown in FIG. 4, the arrangement of FIG. 5 thus performs both wavelength and polarization demultiplexing to accomplish the FOV spatial or angular expansion.

More specifically, in FIG. 5 the original image with a 90 degree FOV is divided into sub images “A”+“E” assigned a wavelength of 658 nm with S polarization, sub images “B”+“D” are assigned a wavelength of 638 nm with S polarization and sub image “C” is assigned a wavelength of 638 nm with P polarization having a 30 degree angular bandwidth. As shown, the wavelength/polarization de-multiplexing and re-mapping is accomplished using a 5-layer VHG stack with VHGs L1, L2, L3, L4 and a Wire Grid Polarizer (WGP). As in FIG. 4, in one implementation the VHG-WGP stack may be fabricated with single exposure of t=16 um photopolymer and the subsequent stacking of the holograms on top of the WGP.

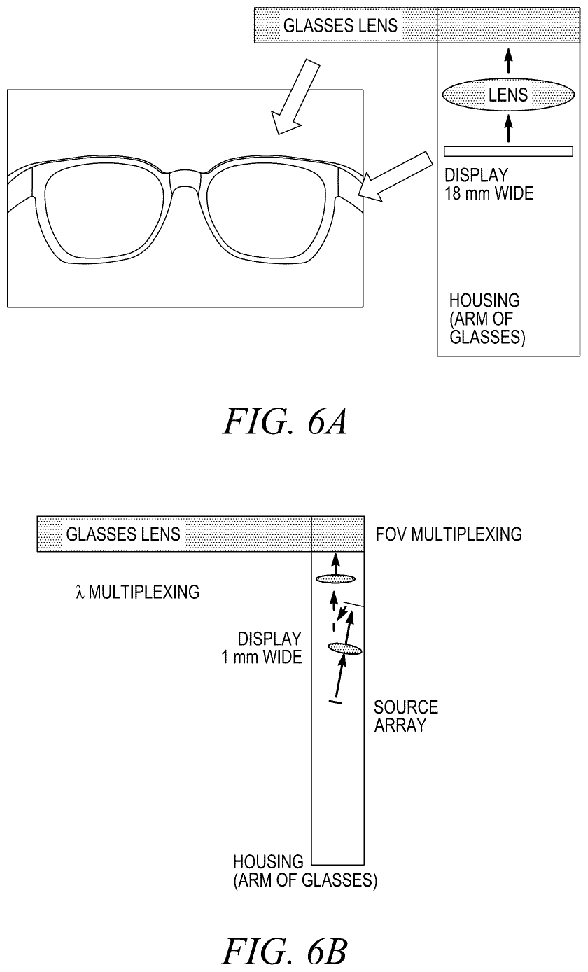

FIG. 6 shows the use of the systems and techniques described herein in an AR near eye display (NED). In particular, FIG. 6a shows a conventional AR-NED and FIG. 6b shows an AR-NED that employs the systems and techniques described herein in a multiplexed AR-NED display engine is used to project 90 degree horizontal FOV images. By multiplexing sub images with smaller individual FOVs, a small display may be used to generate a large FOV image without sacrificing resolution.

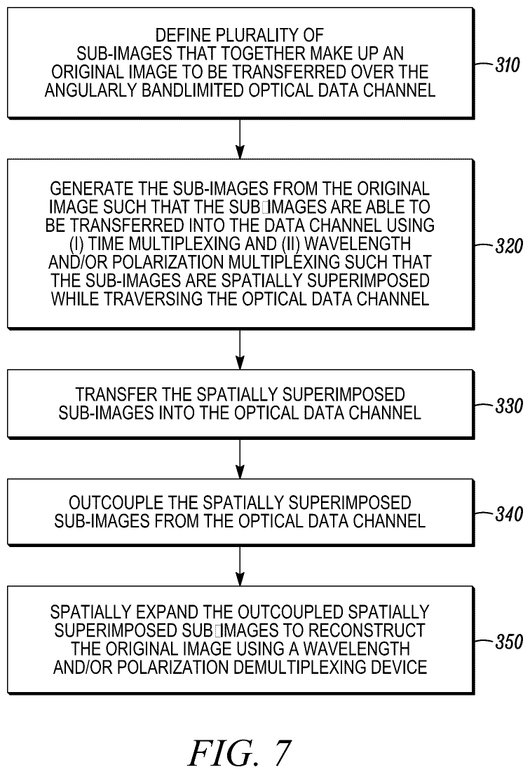

FIG. 7 is flowchart showing one example of a method for transferring an image over an angularly bandlimited optical data channel such as an image guide device. In step 310 a plurality of sub-images is defined that together make up an original image to be transferred over the angularly bandlimited optical data channel. Each of the sub-images have a field-of-view (FOV) less than a FOV of the original image and less than is able to be transferred through the data channel. In step 320 the sub-images are generated from the original image such that the sub-images are able to be transferred into the data channel using (i) time multiplexing and (ii) wavelength and/or polarization multiplexing such that the sub-images are spatially superimposed while traversing the optical data channel. In step 330 the spatially superimposed sub-images are transferred into the optical data channel. The spatially superimposed sub-images are outcoupled from the optical data channel in step 340. The outcoupled spatially superimposed sub-images are spatially or angularly expanded in step 350 to reconstruct the original image using a wavelength and/or polarization demultiplexing device.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

1. A method for transferring an image over an angularly bandlimited optical data channel, comprising:
defining a plurality of sub-images that together make up an original image to be transferred over the angularly bandlimited optical data channel, wherein each of the sub-images have a field-of-view (FOV) less than a FOV of the original image and is able to be transferred through the data channel;
generating the sub-images from the original image such that the sub-images are able to be transferred into the data channel using (i) time multiplexing and (ii) wavelength and/or polarization multiplexing such that the sub-images are spatially superimposed while traversing the optical data channel;
transferring the spatially superimposed sub-images into the optical data channel;
outcoupling the spatially superimposed sub-images from the optical data channel; and
spatially expanding the outcoupled spatially superimposed sub-images to reconstruct the original image using a wavelength and/or polarization demultiplexing device.

2. The method of claim 1 wherein the wavelength and/or polarization demultiplexing device is configured to angularly direct each of the sub-images to a designated FOV of the original image to thereby reconstruct the original image.

3. The method of claim 2 wherein the wavelength and/or polarization demultiplexing device includes at least a plurality of volume holographic gratings (VHGs) arranged one over another.

4. The method of claim 3 wherein the wavelength and/or polarization demultiplexing device further includes a polarization sensitive device.

5. The method of claim 4 wherein the polarization sensitive device is a wire grid polarizer.

6. The method of claim 1 wherein the optical data channel is an image guide device in which the spatially superimposed sub-images undergo total internal reflection.

7. The method of claim 6 wherein the image guide device is incorporated in an augmented reality near-eye device.

8. An optical device, comprising:
a first volume holographic grating (VHG) configured to angularly direct a first optical wavelength in a first specified angular direction without interacting with at least a second optical wavelength; and
a second volume holographic grating (VHG) arranged to receive the second optical wavelength after traversing the first VHG and being configured to angularly direct the second optical wavelength in a second specified angular direction without interacting with at least the first optical wavelength.

9. The optical device of claim 8 further comprising a polarization sensitive device configured to direct the first optical wavelength having a first polarization state in a third specified angular direction and direct the second optical wavelength having a second polarization state orthogonal to the first polarization state in a fourth specified angular direction.

10. The optical device of claim 9 wherein the polarization sensitive device is a wire grid polarizer.
